(19) United States
(12) Patent Application Publication
(10) Pub. No.: US 2016/0328535 A1
(43) Pub. Date: Nov. 10, 2016

(54) Secure Controlled Substance Pill Dispensing Device

(71) Applicant: Jim Patton, Edmond, OK (US)

(72) Inventor: John Barr, Troutman, NC (US)

(73) Assignee: Jim Patton, Edmond, OK (US)

(21) Appl. No.: 14/704,475

(22) Filed: May 5, 2015

(51) Int. Cl. G06F 19/00; A61J 7/04; G06K 7/10; B65D 83/04

(52) U.S. Cl. CPC G06F 19/3456; B65D 83/04; A61J 7/0472; G06K 7/10009

(57) ABSTRACT

The secure controlled substance dispensing device includes a lid with an RFID reader and a container that engages that lid. The container includes a hopper that is configured to hold a plurality of pills and a tray that is connect that hopper. The container can dispense a pill from the hopper into the tray when an authorized RFID rob is read by the RFID reader.

### FIELD OF THE INVENTION

The present invention generally relates to the field of medication packaging and particularly to the dispensing of pills.

### BACKGROUND OF THE INVENTION

The health industry is faced with a multibillion dollar problem of prescription controlled substance diversion. Patients often either inadvertently or intentionally take their medication too frequently or outside the guidance of their treating physician. This problem is exacerbated when unauthorized persons attempt to utilize pills or other prescribed medication from an authorized patient's pill supply. Accordingly, there is a need for a secure pill dispensing device that will ensure that patients do not take their medication more frequently than prescribed and that unauthorized persons are unable to access the medication.

### SUMMARY OF THE INVENTION

Presently preferred embodiments of the invention include a pill dispensing device. The pill dispensing device preferably includes a container, a lid, and a processing unit. The container preferably includes a first cylinder, a second cylinder, a bottom, a top ring, a dispensing mechanism and a tamper resistance mechanism. The first and second wall of the container form a space containing a conductive solution and are connected to the bottom of the container. The dispensing mechanism preferably includes a hopper, a first trap door, a first chute, a first sensor, a second trap door, a second chute, a second sensor, and a tray. In a preferred embodiment, the hopper is configured to accept a plurality of pills, which are then dispensed through the first chute and the second chute into the tray. The lid engages the container's top ring and preferably includes an RFID reader and a display. The processing unit monitors the conductive solution to ensure that the pill dispensing device has not been tampered with, and when necessary, activates the tamper resistance mechanism to render the plurality of pills unusable.

### BRIEF DESCRIPTION OF THE DRAWINGS

FIG. 1 is a side cross-sectional view of the secure controlled substance pill dispenser.

FIG. 2 is a top view of the lid of the secure controlled substance pill dispenser.

FIG. 3 is a top cross-sectional view of the secure controlled substance pill dispenser container and lid.

FIG. 4 is a schematic diagram of the components of the processing module.

### DETAILED DESCRIPTION OF THE PREFERRED EMBODIMENTS

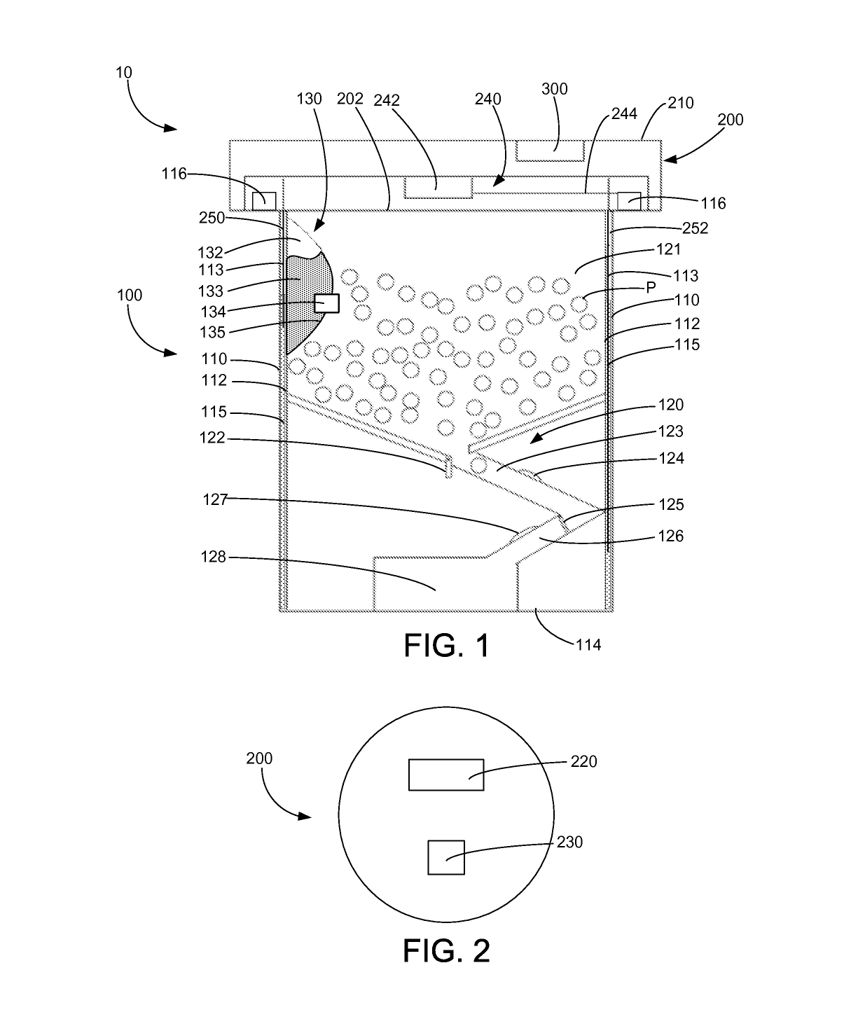

In accordance with a preferred embodiment of the present invention, FIG. 1 shows a cross-sectional side view of a pill dispensing device 10. The pill dispensing device 10 includes a container 100, a lid 200 and a processing unit 300. As shown, the container 100 includes a top ring 116 that engages the lid 200. In the preferred embodiment the processing unit 300 is displaced within a recess in the lid 200, but it will be understood that numerous placements of the processing unit 300 are possible without any restriction in the utility of the pill dispensing device 10.

In the preferred embodiment, the container 100 is cylindrical and includes a first cylinder 110, a second cylinder 112, a bottom 114, the top ring 116, a dispending mechanism 120 and a tamper resistance mechanism 130. The first cylinder 110 and second cylinder 112 are formed so that the diameter of the first cylinder 110 is greater than the diameter of the second cylinder 112. Both the first cylinder 110 and second cylinder 120 engage the bottom 114. It is understood that the positioning of the first cylinder 110 and the second cylinder 112 forms a space 113 between the first cylinder 110 and second cylinder 112. This space 113 is filled with a conductive liquid 115 capable of conducting an electric current.

The dispensing mechanism 120 is positioned within the second cylinder 112 of the container 100, and includes a hopper 121, a first trap door 122, a first chute 123, a first sensor 124 a second trap door 125, a second chute 126, a second sensor 127 and a tray 128. The hopper 121 is configured to hold pills (P). The first trap door 122 engages the hopper 121 in a manner that permits the first trap door 122 to selectively open and close. Notably, FIG. 1 depicts the first trap door 122 in an open position. The first trap door 122 also engages with the first chute 123 such that when the first trap door is open, pills (P) can move from the hopper 121 into the first chute 123. The first sensor 124 is positioned alongside the first chute 123 so that it can detect the presence of a pill (P) in the first chute 123. The second trap door 125 is positioned between the first chute 123 and the second chute 126. The second trap door 125 can selectively be in an open or closed position. In a closed position, the second trap door 125 prevents pills (P) from moving from the first chute 123 to the second chute 126. Notably, in FIG. 1, the second trap door 125 is depicted in a closed position. The second sensor 127 is positioned alongside the second chute 126 so that it can detect the passage of a pill (P) in the second chute 126. The second chute 126 also engages the tray 128 such that a pill (P) passing through the second chute 126 will be delivered into the tray 128.

In the preferred embodiment, the tamper resistance mechanism 130 is positioned within the hopper 121 and includes a fluid vessel 132, a tamper resistance fluid 133, and a rupture device 134. The tamper resistance fluid 133 is contained within the tamper resistance vessel 132, and may consist of a variety of fluids that would spoil or otherwise damage the pills (P) upon exposure. Such fluids are known in the art, and include without limitation saline, food dye and syrup of ipecac. It will be understood that the particular makeup of the tamper resistance fluid 133 may depend upon the particular makeup of the pills (P) being used in the embodiment of the pill dispensing device 10. The fluid vessel 132 has a first surface 135 that engages the rupture device 134. The rupture device 134 is capable of rupturing the first surface 135 such that the tamper resistance fluid 133 will spill out of the fluid vessel 132 and engage the pills (P) within the hopper 121, rendering such pills (P) less functional or alternatively unusable. It will be understood that while FIG. 1 depicts the tamper resistance mechanism 130 engaged with the hopper 121, other configurations are possible. In an alternative embodiment, the tamper resistance mechanism is attached to an underside 202 of the lid 200.

Turning to FIG. 2, shown therein is a top-view of the lid 200 of the pill dispensing device 10, which includes a display 220 and an RFID reader 230. As further depicted in FIG. 1 the lid 200 further includes a locking mechanism 240, a first wire 250 and a second wire 252. The display 220 is connected to the processing unit 300 and displays relevant information which may include the number of pills (P) in the pill dispensing device 10, the amount of time left until a new pill (P) can be dispensed, and other general information which may include the contact information regarding the pharmacy where the pill dispensing device 10 was obtained, personal information regarding the user of the pill dispensing device 10. It will be understood that the RFID reader 230 is also connected to the processing unit 300 and is configured to communicate with an RFID fob or other similar device.

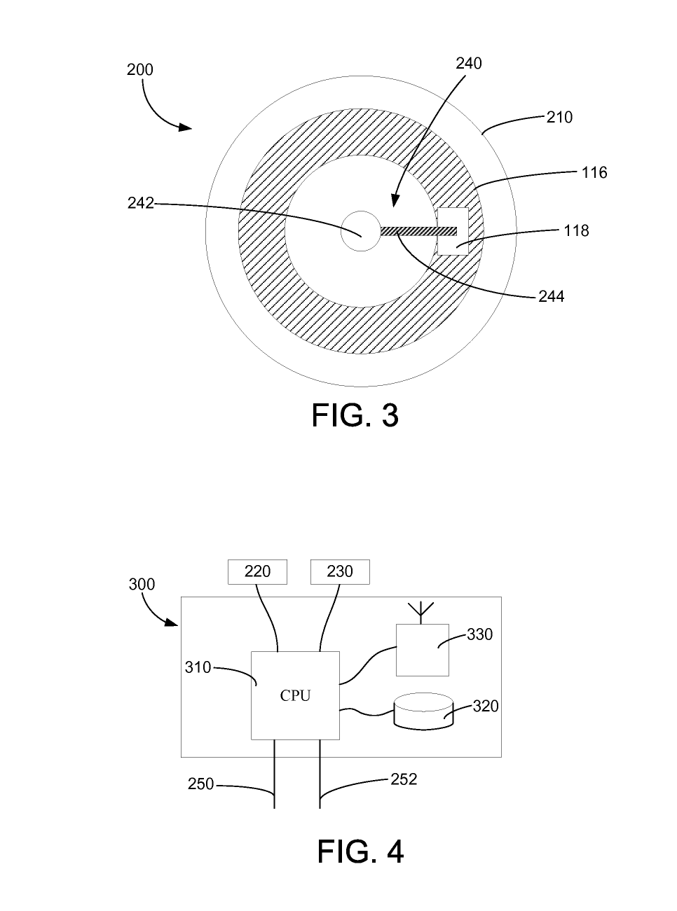

Turning to FIG. 3, depicted therein is a cross-sectional view of the interface between the container 100 and the lid 200 that particularly shows the locking mechanism 240 of the lid 200. As shown, the locking mechanism 240 includes a servo motor 242, and a locking pin 244. In the preferred embodiment, the servo motor 242 is centrally located on the bottom of the lid 200 and is connected to the processing unit 300 (not depicted in FIG. 3) and the locking pin 244. The locking pin 244 is selectively capable of being extended and retracted by the servo motor 242. When extended, the locking pin 244 fits into a recess 118 that is formed into the top ring 116 of the container 100. Notably, FIG. 3 shows the locking pin 244 in the extended position. In this position, the locking pin 244 prevents the disengagement of the lid 200 with the container 100, effectively locking the pill dispensing device 10, and preventing the extraction of pills (P) from the container 100. It will be understood that alternative embodiments of the locking mechanism 240 are possible. In one alternative embodiment, the locking mechanism 240 includes of a plurality of locking pins 240, each of which fits in each of a plurality of recesses 118 formed into the top ring 116.

Turning back to FIG. 1, the first wire 250 and second wire 252 extend from the lid 200 into the space 113 between the first wall 112 and the second wall 113 of the container 100. The first wire 250 and second wire 252 are both configured to engage the conductive liquid 115. In the preferred embodiment show in FIG. 1, the first wire 250 is shorter than second wire 252.

Turning to FIG. 4, depicted therein is a schematic of the processing unit 300, which includes a CPU 310, a data store 320, and may include a communication module 330. It will be understood that these components can be either combined or divided into different physical components as desired. For example, the functions of the CPU 310 and the data store 320 could be combined into a single physical component, or the functions of the communications module 330 could be divided into several different physical components.

In the preferred embodiment, the communications module 330 is a universal serial bus port that will accepts a standard USB cable and is configured to communicate with a personal computer. It will be understood, however, that the communications module 300 may also support other communications protocols including wifi, bluetooth, etc., so long as the communications module can communicate with a personal computer.

Now referring to FIGS. 1-4, the processing module 300 is connected to the dispensing mechanism 120, the tamper resistance mechanism 130, the display 220, the RFID reader 230, the locking mechanism 240, the first wire 250 and the second wire 252. In operation, the processing module 300 manages the various functions of the components of the pill dispensing device 10.

It will be understood that a pharmacist must first setup the pill dispensing device 10 before it can be used by a patient. In the preferred embodiment the pharmacist must first open the pill dispensing device 10 by bringing an authorized RFID fob in proximity with the RFID reader 230. The RFID reader then signals the processing unit 300 that an authorized RFID fob has been used. The processing unit 300 will then signal the locking mechanism 240 to selectively change the position of the locking pin 244, which thereby either locks or unlocks the lid 200 from the container 100.

In an alternative embodiment, the pharmacist opens the pill dispensing 10 by plugging a USB cable into the communications module 330 thereby connecting with the personal computer. So long as the USB cable is plugged into the communications module 330, the locking mechanism 240 will maintain the locking pin 244 in an open position. As soon as the USB cable is removed from the communications module 330, the locking mechanism 240 will change the position of the locking pin 244 into a closed position. In a further aspect of this alternative embodiment, once the USB cable is connected to the communication module 330, an authentication code specific to the pharmacist's pharmacy is stored by the processing unit 300. Thereafter, the locking mechanism 240 cannot be disengaged unless the authentication code specific to the pharmacist's pharmacy is transmitted by the pharmacist over the USB cable to the communication moule 330. It will be understood that this functionally “pairs” the pill dispensing device 10 with the pharmacists' pharmacy thereby preventing the user from using that pill dispensing device 10 with at a different pharmacy.

Once the lid 200 is removed from the container 100, the pharmacist fills the hopper 121 with the desired type and number of pills (P). The pharmacist then uses a personal computer to communicate with the processing unit 300 via the communications module 330. In particular, the pharmacist will indicate how often a pill (P) can be dispensed, how many pills were loaded into the hopper 121, and a code identifying a patient RFID fob. In alternative embodiments, the pharmacist may indicate what type of pills (P) were loaded into the hopper 121, whether any refills will be allowed, the patient's name and other related personal information. Such information is stored on the data store 320 as needed. Once the pharmacist has indicated all of the desired information, the lid 200 is engaged back onto the top ring 116 of the container 100, which is then locked by the locking mechanism 240, and the pill dispensing device 10 is given to the patient for use.

A patient operates the pill dispensing device 10 by placing a personal RFID fob in close proximity with the RFID reader 230. After detecting the patient's RFID fob, the RFID reader 230 will signal the processing unit 300 that the patient wishes to dispense one of the pills (P). The processing unit 300 will then evaluate the request against the information previously entered by the pharmacist. In particular, the processing unit 300 will determine if enough time has passed since the last pill was dispensed, and if this particular patient RFID fob is authorized. For example, if the pharmacist desires the particular type of pills (P) in the pill dispensing device 10 to be used only once every 4 hours, then the processing unit 300 will determine whether 4 hours has passed since the last pill (P) was dispensed. If 4 hours have not passed, then the processing unit 300 will signal the display 220 to display the amount of time left until a pill (P) can be dispensed.

Alternatively, if the processing unit 300 determines based upon the information input by the pharmacist, that a pill (P) can be dispensed, then the processing unit 300 will signal the first trap door 122 to open so that a pill (P) can move from the hopper 121 into the first chute 123. When a pill (P) moves from the hopper 121 past the first trap door 122 into the first chute 123, the first sensor 124 signals the processing unit 300 that a pill (P) is now in the first chute 123. The processing unit 300 will then signal the first trap door 122 to close, and then signal the second trap door 125 to open, thus preventing any more pills (P) from moving into the first chute 123 and permitting the pill (P) in the first chute 123 to move through the second chute 126 into the tray 128. As the pill (P) passes through the second chute 126, the second sensor 127 signals the processing unit 300 and indicates that a pill (P) has been dispensed into the tray 128. The processing unit 300 counts the number of pills of dispensed and stores that count in the data store 320. The number of dispensed pills can then be later communicated to the pharmacist via the communications module 330. After a pill is dispensed, the processing unit 300 then signals the second trap door 125 to close. The patient may then open the tray 128 and retrieve the dispensed pill (P).

It will therefore be understood that unauthorized users (those without an authorized patient RFID fob) are unable to dispense pills (P) from the pill dispensing device 10. It will also be understood that even authorized users (those with an authorized patient RFID fob) can only dispense pills (P) in accordance with the schedule indicated by the pharmacist when the pill dispensing device 10 was setup.

The pill dispensing device 10 is further secured through the operation of the tamper resistance mechanism 130. It will be understood that the processing unit 300 monitors the conductive liquid 113 by passing a current from the first wire 250 through the conductive liquid 113 to the second wire 252. It will be further understood that if a user attempts to tamper with the pill dispensing device 10 by breaking through the first cylinder 110 of the container 100, the conductive liquid 115 will spill through any rupture in the first wall 100 thus breaking the circuit between the first wire 250, the conductive liquid 115 and the second wire 252. When the processing unit 300 detects that circuit break, it signals the tamper resistance mechanism 130 to activate. As discussed above, activation of the tamper resistance mechanism 130 will result in rending the pills (P) unusable. It will be understood that because the first wire 250 and second wire 252 are preferably of different lengths, the function of the tamper resistance mechanism 130 cannot be circumvented by tilting the pill dispensing device 10 upside down to ensure at the conductive liquid 115 maintains contact with the first wire 250 and second wire 252.

It is clear that the present invention is well adapted to carry out its objectives and attain the ends and advantages mentioned above as well as those inherent therein. While presently preferred embodiments of the invention have been described in varying detail for purposes of disclosure, it will be understood that numerous changes may be made which will readily suggest themselves to those skilled in the art and which are encompassed within the spirit of the invention disclosed, as defined in the written description and appended claims.

1. (canceled)

2. (canceled)

3. (canceled)

4. A pill dispenser, comprising:
a lid; and
a container, engaging the lid, the container comprising:
a hopper positioned within the container and configured to hold a plurality of pills; and
and
a tamper resistance mechanism configured to render the plurality of pills in the hopper unusable.

5. (canceled)

6. The pill dispenser of claim 4 further comprising:
a processing unit configured to store a time period that must pass between the dispensing of each one of the pills in the plurality of pills and to prevent the dispensing of any one of the pills in the plurality of pills more than once during the time period.

7. The pill dispenser of claim 4, the lid further comprising:
a display configured to show the number of pills left in the hopper.

8. The pill dispenser of claim 6, wherein the tamper resistance mechanism is configured to dispense a tamper resistance fluid to render the plurality of pills in the hopper unusable.

9. The pill dispenser of claim 8, the processing unit further comprising:
a communications module configure to engage with a personal computer and to receive information regarding the dispensing of the plurality of pills.

10. The pill dispenser of claim 8, wherein in the information received by the communications module includes the time period.

11. The pill dispenser of claim 10, wherein the communications module is a USB interface.

12. The pill dispenser of claim 10 wherein the communication module can use a wireless protocol to communicate with the personal computer.

13. The pill dispenser of claim 12, wherein the tamper resistance fluid is ipecac.

14. The pill dispenser of claim 12, wherein the tamper resistance fluid is saline.

15. The pill dispenser of claim 12, wherein the tamper resistance fluid is food dye.

16. The pill dispenser of claim 12, wherein the tamper resistance fluid is a mixture consisting of at least two items selected from the following group: ipecac, saline, food dye.

17. (canceled)

18. (canceled)

19. (canceled)

20. (canceled)

21. (canceled)
